(19) United States
(12) Patent Application Publication
(10) Pub. No.: US 2006/0277760 A1
(43) Pub. Date: Dec. 14, 2006

(54) Razor blades and assemblies therefor

(76) Inventor: Sangyong Lee, Rego Park, NY (US)

Correspondence Address: Mitchell A. Stein, Esq.;STEIN LAW, P.C., Suite 4, 24 Woodbine Avenue, Northport, NY, 11768, US

(21) Appl. No.: 11/152,482

(22) Filed: Jun. 14, 2005

(51) Int. Cl. B26B 21/00

(52) U.S. Cl. 30/50; 30/49

(57) ABSTRACT

A razor blade head assembly having at least two razor blades, with one blade of convex curvature housed in the head assembly and a straight blade. Also the razor blade head assembly can have a third blade situated between the first and straight blade, with less of a curvature than the first blade. The blades preferably have a single bevel. Also shown is a razor blade assembly for cutting hair extending from skin, having a handle, a head assembly removably mounted to the handle and having three single-beveled blades, in which a first blade of convex curvature first contacts and cuts the hair, a second blade is proximately located behind the first blade and has a lesser convexity than the first blade for second contact with and cutting of the hair, and a straight blade proximately located behind the second blade for smoothing the skin.

### FIELD OF THE INVENTION

The present invention relates to the field of razor blades and assemblies therefor, and more specifically to razors that are used for shaving facial or other human body hair in a manner that minimizes tearing of the hair while maximizing cutting of hair and smoothing the finish to the human skin after the cutting application.

### BACKGROUND OF THE INVENTION

Many students study razor blades and assemblies in business classes as a strong example of how a single handle can be sold where the disposable elements, to wit, the blades, are replaced with frequency. This business model typifies a successful business schematic. Yet, while attention has been given to the disposable elements that contain the blades, attention to the blades themselves has been lost. Indeed, many blade assemblies are often times identical, where the only difference to the purchaser is in the brand selected.

Thus, it is known to use single blade assemblies, as well as multiple blade assemblies in tandem. The idea of multiple blades has been to increase the amount of cutting. Likewise, blades, while themselves flexible (often comprising steel) are made more flexible with an eye towards contouring the blade to that of the face, arm, armpit or leg of the person, where typical hair removable by cutting occurs.

By way of example, U.S. Pat. No. 6,449,218 to Rocha shows a four sided dual blade shaver having blades that are both straight and convex. U.S. Pat. No. 4,901,437 to Iten shows a concave shaving head. U.S. Pat. No. 6,055,731 to Zucker shows a convex blade assembly in a pseudo-cylindrical configuration. Concave assemblies are also shown in U.S. Pat. No. 5,979,056 to Andrews primarily for use on legs, arms and underarm regions.

Yet, in razors with multiple blades placed in tandem, the manufacturer claims that the first blade performs the majority of cutting in a downward direction (i.e., the direction of movement of the assembly against the skin), and the second blade is claimed to perform roughing. In instances where a third blade is employed, the third blade typically is claimed for smoothing. However, with three identical blades in the same configuration of blade angles, the claims fail to be completely accurate. It has been observed by the inventor herein, and as a matter of physics and study, that three identical blades do not possibly cut the same hair strand in anything but different heights as they pass along the hair strands. Shaving deepness only depends, then, on how hard the pressure is applied by the razor against the skin. By way of analogy, if one considers two object floating on water, where one is convex in the front, and the other is flat in the front, it is obvious that the convex object will have better cruising (and less friction) along the surface of the water because the convex object has less resistance than the flat object while each is in motion.

It has also been observed in wood working, that the larger the curvature of a plane blade, the more removal of material occurs but the finish is not left smooth. It is then obvious that a curved cutting edge has a longer surface distance for cutting than a straight edge at any given width. Thus, convex blades can cut more strands of hair than straight blades because of a larger surface distance for cutting.

It is thus an object of the instant invention to provide a razor assembly having a multiplicity of cutting edges that are not all identical.

It is a further object of the instant invention to provide a razor assembly wherein initial cuts of hair are performed by a curved blade, and subsequent blades are of less curvature to the point of finally having a straight blade.

It is a still further object of the instant invention to provide not just cutting (without ripping of the hair) but, as well, smoothing by cutting leaving the skin smoothly finished.

It is yet a still further object of the instant invention to provide a cutting blade in a razor assembly that does not damage skin otherwise caused by double beveled edges.

### SUMMARY OF THE INVENTION

The various features of novelty which characterize the invention are pointed out with particularity in the claims annexed to and forming a part of the disclosure. For a better understanding of the invention, its operating advantages, and specific objects attained by its use, reference should be had to the drawings and descriptive matter in which there are illustrated and described preferred embodiments of the invention.

The foregoing objects and other objects of the invention are achieved through a razor blade head assembly having at least two razor blades, with one blade of convex curvature housed in the head assembly and a straight blade. Also the razor blade head assembly can have a third blade situated between the first and straight blade, with less of a curvature than the first blade. The blades preferably have a single bevel.

Also shown is a razor blade assembly for cutting hair extending from skin, having a handle, a head assembly removably mounted to the handle and having three single-beveled blades, in which a first blade of convex curvature is housed in the head assembly for first contact with the hair to be cut from the skin and for cutting the hair, a second blade is proximately located behind the first blade and having a lesser convexity than the first blade for second contact with the hair to be cut from the skin and for second cutting of the hair; and a straight blade proximately located behind said second blade for third contact with the hair to be cut from the skin and for cutting said hair and smoothing the skin.

Other features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### BRIEF DESCRIPTION OF THE DRAWINGS

In the drawings, wherein similar reference characters denote similar elements through the several views:

FIG. 1 shows a perspective view of a preferred embodiment of the subject invention having three blades of differing curvature such that cutting, intermediate smoothing and final smoothing occur;

FIG. 2 shows a breakout perspective view of each of the blades shown in FIG. 1, in accordance with a preferred embodiment of the subject invention;

FIG. 3 shows a perspective view of an alternative embodiment of the subject invention having two blades, wherein one blade is convex, and the second is of less convexity, generally straight-edged;

FIG. 4 shows a breakout perspective view of each of the blades shown in FIG. 2, in accordance with the alternative embodiment of the subject invention shown therein; and

FIG. 5 shows a comparison between a double-beveled cutting edge known in the prior art and a single-beveled cutting edge of the preferred embodiment of the subject invention.

Other aspects of the invention will be clear when the FIGURES are viewed in connection with the specification and other portions set forth herein.

### DETAILED DESCRIPTION OF THE PREFERRED EMBODIMENTS

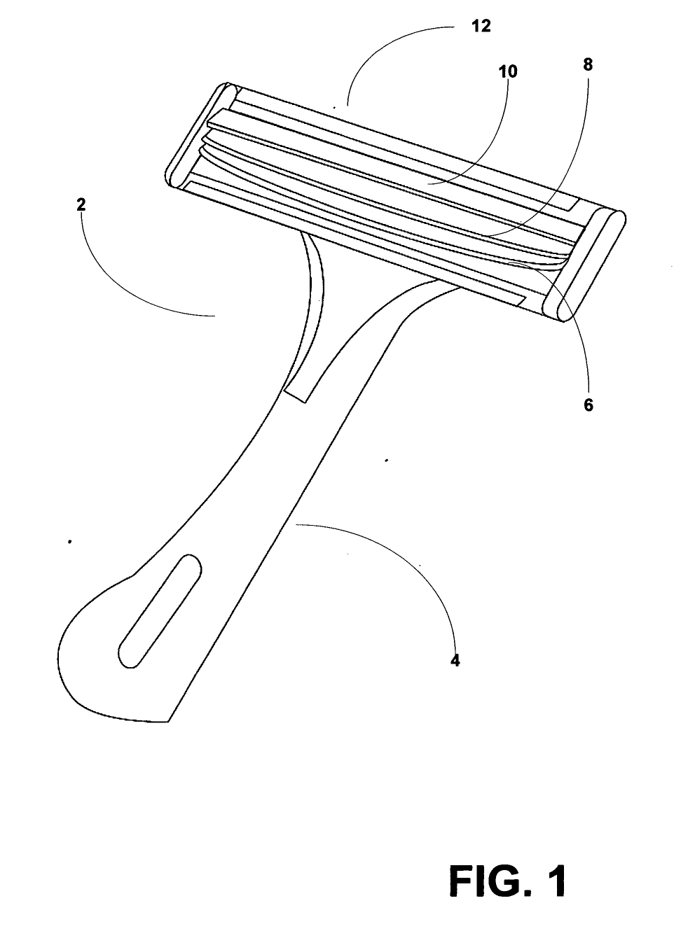

In accordance with the subject invention, FIG. 1 shows razor blade assembly 2, having handle 4 and blade assembly 12, wherein blade assembly 12 comprises three blades 6, 8 and 10 each of varying convexity, such that the first blade that contacts the skin and hair for cutting is blade 6 (having the greatest convexity), the second blade that contacts the skin for intermediate smoothing is blade 8 (having lesser convexity), and the third blade that contacts the skin for smoothing is straight blade 10.

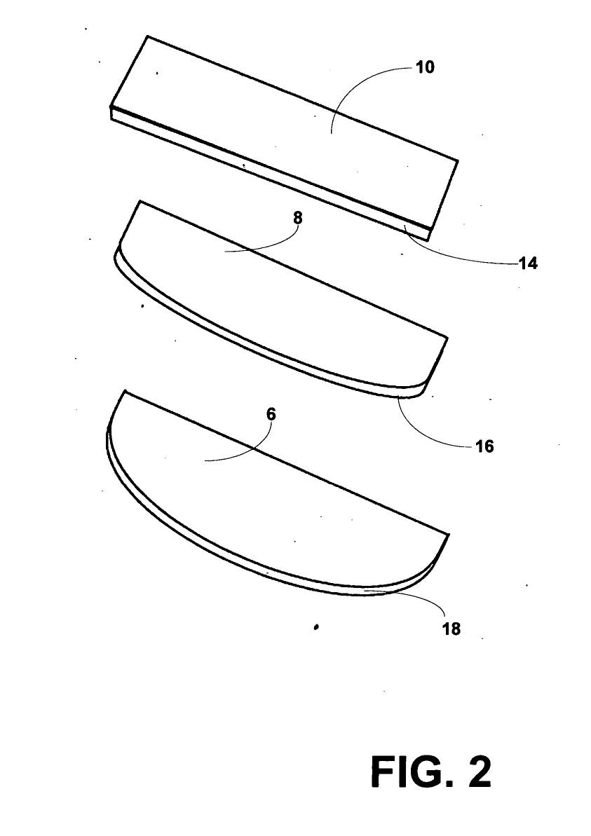

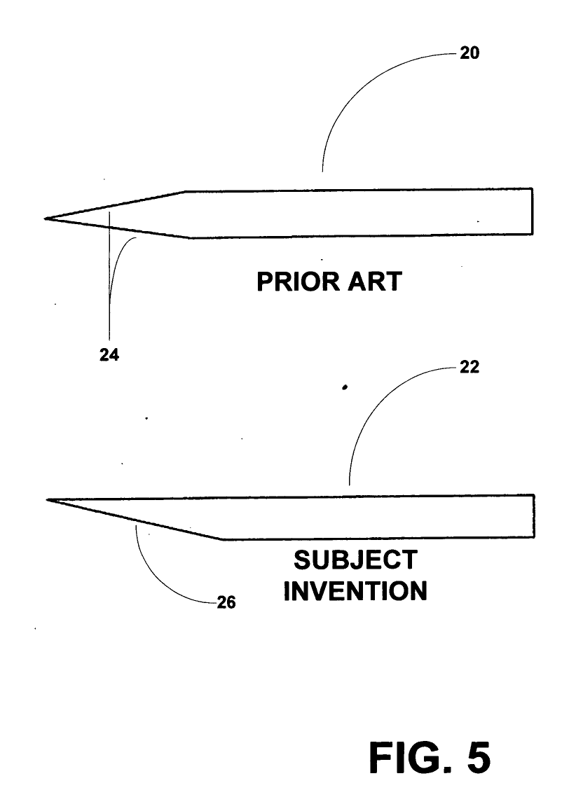

FIG. 2 shows the breakout of the three blades 6, 8 and 10 which together are contained in blade assembly 12 as shown in FIG. 1. These three blades containing cutting surfaces 18, 16 and 14 respectively. As can be seen, these are each single beveled blades, in accordance with the preferred embodiment of the subject invention. A greater description of the single bevel, in comparison with the double bevel, is explained in greater detail in connection with FIG. 5.

As can be observed by the configuration of FIGS. 1 and 2, the first convex blade 6 cuts more strands than would a straight blade (because the circumferential distance is greater) and thus can more easily glide through heaps of hair and sweep many hairs roughly with one stroke. Consecutively, blade 8, the second in the series, having less of a curvature, acts to perform intermediate smoothing and cutting of the hair (which is also at times extended by first blade 6, thereby preparing the hair for cutting by blade 8). Finally, the third straight blade performs finally smoothing and finishing, leaving the skin surface in a smooth state and the hair fully cut below the initial cutaneous surface.

As with many multi-blade razor devices, the first blade is most likely damages or chipped because it is the first to stroke-the skin and hair. If damaged, head 12 is configured to be removed from handle 4 (in typical fashion known by one of ordinary skill in the art), and discarded. The result of the tandem is thus an extended life due to spreading the work load among the three blades, and especially because the three blades are not of identical convex configuration. In operation, straight blades drag debris which provides for ineffective shaving; however convex blades push debris radially and relieve obstacles from movement of the subsequent blades during operation of the razor assembly. As a result of this configuration, sludge (i.e., a combination of hair, skin and cream) that normally accumulates generally does not gather between the blades, since the blades are of differing convex geometry, with the last blade as a straight blade.

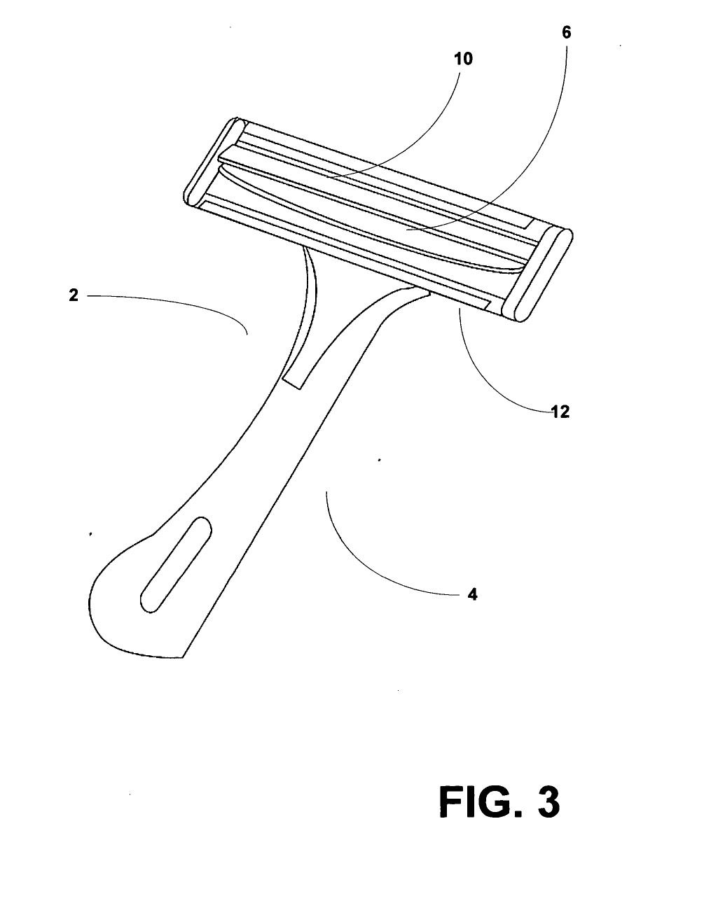

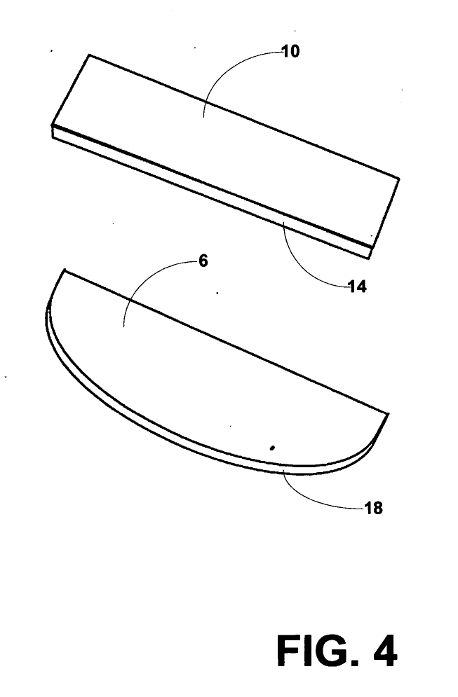

FIG. 3 shows an alternative embodiment, wherein assembly 2 has handle 4, and shaving head 12 having but two blades 6 and 10. Like that shown hereinabove, blades 6 and 10 are of the same style configuration, also as shown in FIG. 4, wherein the blades are revealed outside of the assembly for more easy viewing. As above, the curvature of blade 6 performs the major cutting while smoothing is accomplished by blade 10. Each have respective cutting surfaces 18 and 14, which are shown to be a single bevel, which is also important for performance.

In particular, FIG. 5 shows the typical prior art blade 20 having double-beveled cutting edges 24, while that of the subject invention has blades of configuration 22, having a single bevel 26. Observing the function of tools for scraping and planing wood, applied uniquely to that of cutting human hair, is helpful in understanding the features associated with the use of a single-beveled cutting edge. In particular, the single bevel minimizes the tearing effect that typifies the use of a double bevel. Like wood, a double bevel tends to “lift” the wood fibers below the surface, and a tear-out occurs. Many people have experienced a tearing effect with the use of razors (whether new or used) as a result of the double bevel that typifies such blades. Thus, the single bevel, like its use in wood, eliminates the pulling and tearing effect, minimizes nicks and cuts, and like a Japanese kitchen knife (with a single bevel) does not cut deeply and rather smooths the surface of the skin. Thus, the use of a single bevel improves cutting, minimizes the build up of debris, and leaves the skin smooth and less irritated than that of the prior art.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

I claim:

1. A razor blade head assembly having at least two razor blades, comprising:
(a) at least one blade of convex curvature housed in the head assembly; and
(b) a straight blade.

2. The razor blade head assembly of claim 1, wherein said blades have a single bevel.

3. The razor blade head assembly of claim 1, further comprising a third blade, situated between said at least one blade and the straight blade.

4. The razor blade head assembly of claim 3, wherein said third blade is of lesser convexity than the at least one blade.

5. A razor blade assembly for cutting hair extending from skin, comprising:
(a) a handle;
(b) a head assembly removably mounted to said handle, comprising three single-beveled blades, wherein:
(1) a first blade of convex curvature is housed in the head assembly for first contact with the hair to be cut from the skin and for cutting said hair;
(2) a second blade proximately located behind said first blade and having a lesser convexity than said first blade for second contact with the hair to be cut from the skin and for second cutting said hair; and
(3) a straight blade proximately located behind said second blade for third contact with the hair to be cut from the skin and for cutting said hair and smoothing the skin.
